(19) United States
(12) Patent Application Publication
(10) Pub. No.: US 2011/0145710 A1
(43) Pub. Date: Jun. 16, 2011

(54) FRAMEWORK TO VISUALIZE NETWORKS

(75) Inventors: Volker Albert, Leimen (DE); Juergen Poehler, Rauenberg (DE); Martin Hoffman, Karlsruhe (DE)

(73) Assignee: SAP AG, Walldorf (DE)

(21) Appl. No.: 12/639,739

(22) Filed: Dec. 16, 2009

(51) Int. Cl. G06F 3/01

(52) U.S. Cl. 715/734

(57) ABSTRACT

A system or method to provide efficient visualization and manipulation of investigative case management (ICM) networks. An entry point into the network is defined. The system accepts a network view definition from a user. The network is filtered based on the view definition and on a filtered view is displayed to a user.

### BACKGROUND OF THE INVENTION

1. Field

Embodiments of the invention relate to investigative case management (ICM). More particularly, embodiments of the invention relate to visualization and manipulation of investigative case networks.

2. Background

Historically, police agencies have administered criminal cases using paper files containing various forms of written reports. As cases become increasingly complex with large numbers of suspects, witnesses, locations, objects, like vehicles or weapons, and as further instances or incidents occur, paper files become increasingly cumbersome and unyielding. Most police departments have transitioned to computer based case management, which has improved the ability to track a large number of entities and their relationships for individual cases. In this context, the knowledge about the case is put into a system in a structured way so that the entities and their relationships are maintained. However, this results in a huge network of entities and relationships making it difficult to identify important features of the data by virtue of its sheer volume. An effective way to visualize and manipulate these networks is desirable.

### SUMMARY

A system or method to provide efficient visualization and manipulation of investigative case management (ICM) networks is disclosed. An entry point into the network is defined. The system accepts a network view definition from a user. The network is filtered based on the view definition and on a filtered view is displayed to a user.

### BRIEF DESCRIPTION OF THE DRAWINGS

The invention is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a block diagram of a system according to one embodiment of the invention.

FIG. 2 is a flow diagram of operation according to one embodiment of the invention.

### DETAILED DESCRIPTION

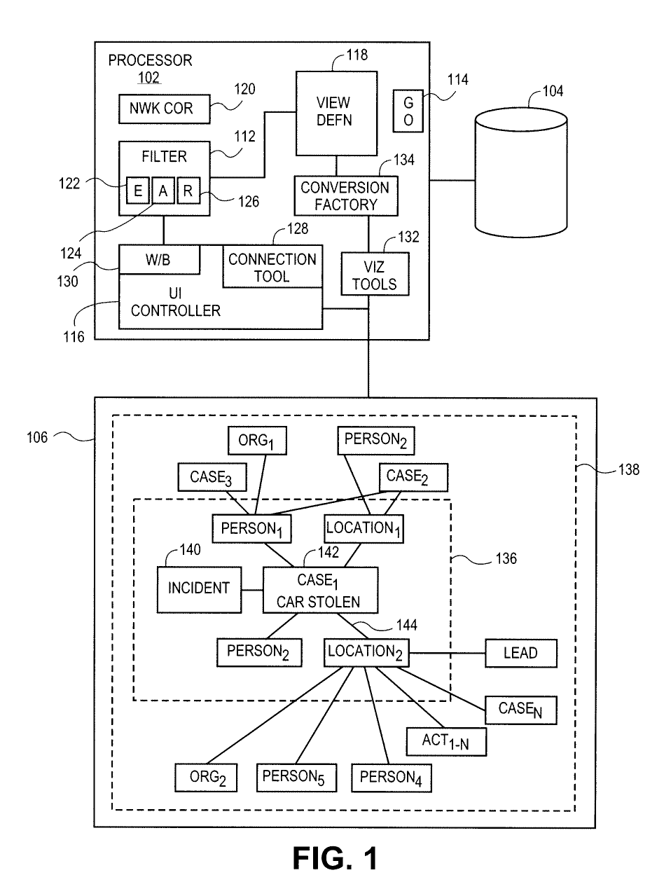

FIG. 1 is a block diagram of a system according to one embodiment of the invention. A processor 102 is coupled to a persistent storage unit 104 and display 106. Persistent storage 104 may retain a number of investigative case management (ICM) networks each comprising a plurality of business objects and relationships between them. In addition to business objects and their relationships other data can also be included in the network structure which is processed/to be visualized. An example of such data could be entities which are extracted via text analysis software from documents attached to business objects. This type of data is referred to herein as “unstructured” data.

Throughout this description, business objects are referred to as representing entities or interchangeably nodes of the network. Relationships are a semantic, such as for a person “has been seen at”, “is an owner of”, “is a brother of”, etc. Similar relational semantics may exist for other types of entities in the network. For example, locations might have a relation “was stolen from” or “was found at”.

The processor 102 includes a library of visualization tools 132. VIZ Tools 132 might visualize the data in the network in a table, a map, a timeline, timetable etc. Each VIZ Tool, e.g. star tree view, map view etc., usually requires a special format, e.g. XML (extensible markup language) data format, CSV (comma separated values) data format etc.

Additional tools may be added to the visualization tools library 132 as they are subsequently developed. Processor 102 also includes a view definition module 118, a filter 112, and a conversion factory 134. View definitions and filter 112 provide the ability to filter on entities 122, their attributes 124 and relationships 126. These filters limit the amount of data displayed and in the case of attribute filtering may expose hidden or previously unknown relationships between entities in the network. All of the network data retrieved from persistent storage 104 is retained in a generic network object 114 instantiated within the processor 102. The conversion factory converts the data held in the generic network object 114 as limited by the filter 112 to the formats required by the various VIZ tools 132.

View definition module 118 accepts a view definition from a user, for example, “case₁ second level of relations” or “show two levels” within an implicit entry into the active case. Such a view definition causes filter 112 to filter on a relation level to limit the portion of the network to be visualized. Notably, the view definition need not be level dependent. For example, a view definition “intervening entities between case one and any related case” would return Person₁, Location₁ and Location₂ shown in box 136 discussed below. This assumes no higher level case with intervening nodes. Generally, the view definition can be arbitrarily constructed to reveal features of the data set of interest. Because the view definition can be arbitrarily defined, very specific features of the network may be revealed. For example, the view definition shows family members of person₁ or show locations and weapons.

Based on the view definition, the visualization tool 132 in UI controller 116 may automatically select a visualization tool 132. For example, “case₁ second level relations” may be appropriately displayed as a star tree while the “weapons and locations” inquiry may best be shown on a map. In some embodiments, the user may specify the desired visualization format and/or reject the tool selected by the system. For example, if the view definition is family relations, but the question is where they live, the system may propose a star tree view as the tool, but a user may prefer and therefore select a map view as the tool. Once the visualization tool is selected, conversion factory 134 converts the business objects of the network into a format suitable for display using the visualization tool. In one embodiment, conversion factory 134 converts business objects into an XML file or a CSV file depending on the visualization tool selected, e.g. star tree view requires CSV format conversion to other file types are also contemplated.

UI controller 116 controls all iteration with the UI. It provides e.g. HTTP access for the VIZ Tool 134 to the network data (converted data in the appropriate format) to be visualized. As show in FIG. 1 a second level star tree of case₁ node 142. Box 136 encloses the first level and box 138 encloses the second level of the star tree. Incident node 140 provides an entry point to the network. Case₁ 142 represents the effective root node for the shown visualization of the network. Within a network many different possible entry points may exist. Additionally, depending on the view selected root node designation is driven by the view definition. As such what may be the root node in one view, may be a leaf in another and vice versa. Lines between nodes, such as relation 144 represent relationships between the entities corresponding to those nodes. More than one relationship may exist between nodes, e.g., case₂ is related to location₂ and person₁. Nodes may include, for example, activities, leads, other cases, persons, organizations, objects and locations. Other types of nodes are also within the scope and contemplation of the invention. In some embodiments, if e.g. non-business object data like unstructured data is present, it may be presented in a list or view format adjacent to the network view.

In one embodiment, mousing over an entity or a relation brings up an overlay window providing greater detail about that entity or relation. For example, mousing over relation 144 may bring up a window indicating a “recovered at” relation with the stolen car of case₁. Also, in one embodiment, clicking on an entity or relation brings up a data entry window in which the existing information about that entity or relation may be displayed and additional information about the entity or relation may be added.

In some embodiments of the invention, UI generator 116 also includes a connector tool 128, which permits a user to graphically connect nodes in network and establish relationships between. In some embodiments, responsive to the creation of a graphical link, a pop up window is generated to accept a further definition of the relationship created. In some embodiments, the UI generator 116 may also include a white board module 130, which permits a user to create entities and relations of a perspective network on the fly. Whiteboard module 130 drives the display of menus from which entities and relationships can be rapidly assembled to create a new network, such as when a new case is opened. If may also generate a data entry table with modifiable field enumerated to ensure capture of relevant information. For example, the “person” table may include first and last name field, birth date, birthplace, city of origin, gender, occupation, nationality, etc. In one embodiment, the entry point for the network or the white boarding is a case overview screen. The case overview should be competed prior to network creation.

In some embodiments, processor 102 may also include a network correlator 120 which compares an active network with other networks in persistent storage 104. The comparison identifies correlations between those networks and the active network that may indicate relationships between cases. When correlations are found, a user may be permitted to add related nodes or increase the expanse of the existing network to encompass other relations or entities from other networks in the persistent storage.

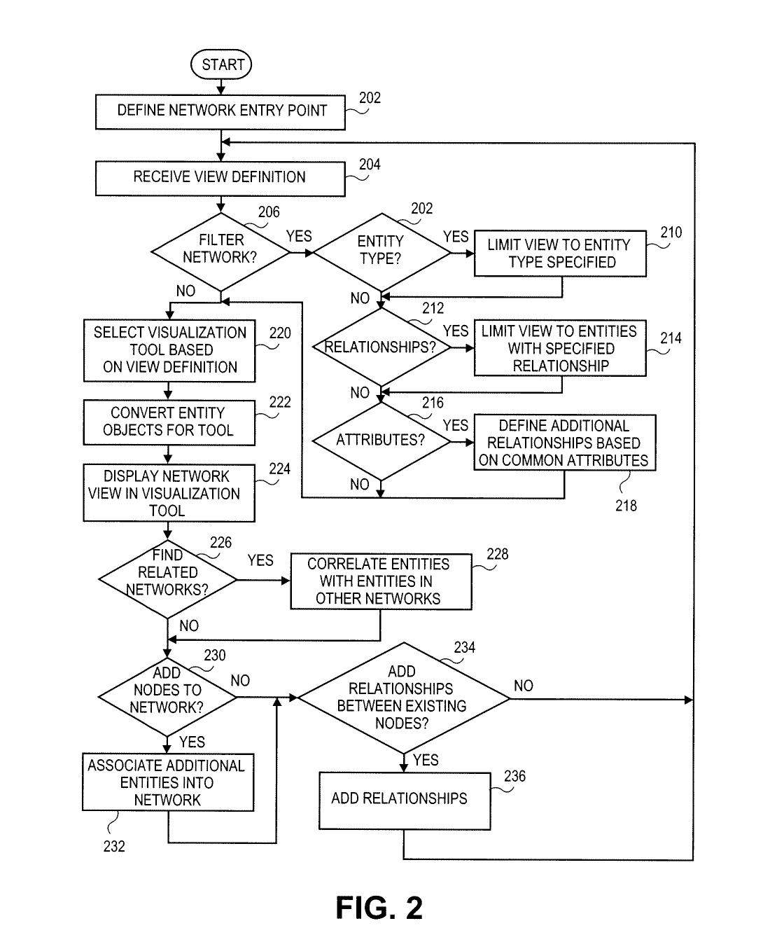

FIG. 2 is a flow diagram of operation according to one embodiment of the invention. Typically, to access a network of business objects, an entry point into the network must be defined. At block 202, an entry point for a network in defined. At block 204, a visualization definition is provided by a user. The visualization definition is used as a basis for limiting entities from the networks to be displayed as well as selection of appropriate visualization format.

A determination is made at block 206 whether filtering of the network is desired based on the visualization definition. If filtering is desired, a determination is made at block 208 if entity type filtering should be performed. If entity type filtering is indicated, the view is limited to the entity type specified at block 210. For example, if the view definition is “people within the levels of suspects”, then entity type filtering would be performed and only people entities would be displayed in the view.

At block 212, a determination is made if relationship filtering is desired. If relationship filtering is desired, such as where the view definition is “family members of suspects”, the view would be limited to persons having a blood relationship with the suspect at block 214.

At block 216, a determination is made whether attribute filtering is desired. If attribute filtering is desired, the system returns those entities having common attributes. This permits additional relationships based on common attributes to be defined at block 218. For example, filtering on membership of an organization may yield unknown relationships between two persons of interest in the network.

Once filtering is completed or no filtering is desired, a visualization tool is selected based on the view definition at block 220. For example, where the view definition relates to geographic relationships, a map visualization tool may be selected, but where the definition relates to temporal relationships, a timeline may be chosen instead. The filtered network objects are then converted to a format suitable for visualization using the visualization tool at block 222. At block 224, a network view is displayed in specified visualization tool.

A determination is made at decision block 226 if it is desired to find related networks. In one embodiment, this is prompted by user request. If related networks are desired, the system correlates entities with entities in other networks and displays found correlations to a user. A determination is made at block 230 if additional nodes are desired to be added to the network. If additional nodes are desired, additional entities are associated in the network at block 232. At block 234, a determination is made whether to add additional relationships from existing nodes. This decision may be based on the finding of additional relations from attribute filtering or because new information has come to light. If additional relationships are desired, they are added to the network at block 236. The user is then free to redefine the view and repeat the process and change the visualization.

While embodiments of the invention are discussed above in the context of flow diagrams reflecting a particular linear order, this is for convenience only. In some cases, various operations may be performed in a different order than shown or various operations may occur in parallel. It should also be recognized that some operations described with respect to one embodiment may be advantageously incorporated into another embodiment. Such incorporation is expressly contemplated.

Elements of embodiments of the present invention may also be provided as a machine-readable medium for storing the machine-executable instructions. The machine-readable medium may include, but is not limited to, flash memory, optical disks, compact disks read only memory (CD-ROM), digital versatile/video disks (DVD) ROM, random access memory (RAM), erasable programmable read-only memory (EPROM), electrically erasable programmable read-only memory (EEPROM), magnetic or optical cards.

In the foregoing specification, the invention has been described with reference to the specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
defining a first entry point for a first investigative case management (ICM) network;
accepting a network view definition in a computer;
filtering the first network, in the computer, based on the view definition; and
displaying a view of the filtered first network on an electronic display.

2. The method of claim 1 further comprising:
identifying a second ICM network having a relation to the first network.

3. The method of claim 2 wherein identifying comprises:
correlating entities in the first network with entities in the second network.

4. The method of claim 2 further comprising:
adding nodes from the second network to the first network based on the relation.

5. The method of claim 1 further comprising:
receiving, through a graphical user interface (GUI), an indication of a relationship between two entities in the network;
storing a relationship between entities in the network based on the indication received.

6. The method of claim 1 further comprising:
automatically selecting a best visualization tool based on the view definition.

7. The method of claim 6 further comprising:
converting a business object representing an entity to a format consistent with the best visualization tool.

8. The method of claim 1 wherein filtering comprises at least one of:
filtering on entity type; or
filtering by relationships.

9. The method of claim 1 further comprising:
filtering on attributes of network entities; and
defining additional relationships between entities based on the attribute filtering.

10. A system comprising:
a persistent storage unit retaining a plurality of business objects associated as nodes of a network;
a library containing a plurality of visualization tools;
a filter to limit a network view based on a set of user specified criteria;
a view definition module to construct a view definition based on user input;
a user interface controller to enable selection of a best visualization tool based on the view definition; and
a display to display the view responsive to the user interface controller.

11. The system of claim 10 further comprising:
a network correlation module to correlate entity existing in two networks.

12. The system of claim 10 wherein the filter filters on entity type, relationship and entity attributes.

13. The system of claim 10 wherein the user interface controller comprises:
a connector tool permitting a user to establish a relationship between two entities in the network.

14. The system of claim 10 further comprising:
a generic object to contain the plurality of business objects within the processor.

15. A computer readable medium having instructions stored thereon that when executed by a processor cause the processor to:
define a first entry point for a first network;
accept a network view definition in a computer;
filter the first network, in the computer, based on the view definition; and
display a view of the filtered first network on an electronic display.

16. The computer readable medium of claim 15 wherein the instructions further cause the processor to:
receive, through a graphical user interface (GUI), an indication of a relationship between two entities in the network; and
store the relationship between entities in the network based on the indication received.

17. The computer readable medium of claim 15 wherein the instructions further cause the processor to:
automatically select a best visualization format based on the view definition.

18. The computer readable medium of claim 17 wherein the instructions further cause the processor to:
convert a business object representing an entity to a format consistent with the best visualization format.

19. The computer readable medium of claim 15 wherein the instructions further cause the processor to:
filter on attributes of network entities; and
define additional relationships between entities based on the attribute filtering.
